(19) United States
(12) Patent Application Publication
(10) Pub. No.: US 2026/0238529 A1
(43) Pub. Date: Aug. 13, 2026

(54) METHOD AND APPARATUS OF SUPPORTING TIMING ADVANCE (TA) ACQUISITION

(71) Applicant: LENOVO (BEIJING) LIMITED, Beijing (CN)

(72) Inventors: Wei LING, Beijing (CN); Yi ZHANG, Beijing (CN); Chenxi ZHU, Fairfax, VA (US); Bingchao LIU, Beijing (CN); Lingling XIAO, Beijing (CN)

(21) Appl. No.: 19/157,090

(22) PCT Filed: Feb. 17, 2023
(86) PCT No.: PCT/CN2023/076770

§ 371 Date: Aug. 15, 2025

(51) Int. Cl. H04L 27/26; H04L 5/00; H04W 56/00; H04W 74/0833

(52) U.S. Cl. CPC H04L 27/26025; H04L 5/0053; H04W 56/0045; H04W 74/0833

(57) ABSTRACT

Embodiments of the present application are related to a method and apparatus of supporting timing advance (TA) acquisition. An exemplary method includes: receiving, from a serving cell on an active bandwidth part (BWP), a physical downlink control channel (PDCCH) order triggering a physical random access channel (PRACH) transmission associated with a candidate cell of a set of candidate cells, wherein, the set of candidate cells is configured by higher layer, and a center frequency of synchronization signal (SS)/physical broadcast channel (PBCH) block (SSB) from the candidate cell is different from a center frequency of SSB from the serving cell; and transmitting, to the candidate cell, the PRACH transmission, wherein a time between a last symbol of the PDCCH order and a first symbol of the PRACH transmission is equal to or greater than a threshold timing gap, wherein the threshold timing gap is based on a radio frequency (RF) switching time.

### TECHNICAL FIELD

The present disclosure relates to wireless communications, and more specifically to techniques for timing advance (TA) (or TA value) acquisition associated with layer 1 (L1)/layer 2 (L2)-triggered mobility (or referred to as “L1/L2 based mobility” or “L1/L2 triggered mobility” etc.).

### BACKGROUND

A wireless communication system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communication system may support inter-cell mobility, wherein mechanism and procedures of L1/L2 based inter-cell mobility for mobility latency reduction need to be settled, including but limited to L1 enhancements for inter-cell beam management and TA management etc.

Therefore, it may be desirable to improve TA acquisition to support L1/L2 based inter-cell mobility.

### SUMMARY OF THE APPLICATION

An objective of the embodiments of the present disclosure is to provide a technical solution of supporting TA acquisition, e.g., a method and apparatus of supporting TA acquisition of an inter-frequency candidate cell in scenarios of L1/L2 based inter-cell mobility, which is at least for mobility latency reduction.

Some embodiments of the present disclosure provide a wireless communication apparatus, e.g., a UE, which includes: a transceiver; and a processor coupled to the transceiver, wherein the processor is configured to: receive, from a serving cell on an active bandwidth part (BWP), a physical downlink control channel (PDCCH) order triggering a physical random access channel (PRACH) transmission associated with a candidate cell of a set of candidate cells, wherein the set of candidate cells is configured by higher layer, and a center frequency of synchronization signal (SS)/physical broadcast channel (PBCH) block (SSB) from the candidate cell is different from a center frequency of SSB from the serving cell; and transmit, to the candidate cell, the PRACH transmission, wherein a time between a last symbol of the PDCCH order and a first symbol of the PRACH transmission is equal to or greater than a threshold timing gap, wherein the threshold timing gap is based on a radio frequency (RF) switching time.

Some other embodiments of the present disclosure provide a wireless communication method, e.g., a method performed by a UE, which includes: receiving, from a serving cell on an active BWP, a PDCCH order triggering a PRACH transmission associated with a candidate cell of a set of candidate cells, wherein the set of candidate cells is configured by higher layer, and a center frequency of SSB from the candidate cell is different from a center frequency of SSB from the serving cell; and transmitting, to the candidate cell, the PRACH transmission, wherein a time between a last symbol of the PDCCH order and a first symbol of the PRACH transmission is equal to or greater than a threshold timing gap, wherein the threshold timing gap is based on a RF switching time.

In some embodiments of the present disclosure, the threshold timing gap is: N_{T,2}+Δ_{BWPSwitching}+Δ_{Delay}+T_{switch}+T_{switch2} msec, where, N_{T,2} is a time duration of N₂ symbols corresponding to a physical uplink shared channel (PUSCH) preparation time for UE processing capability 1 assuming μ corresponds to a smallest subcarrier spacing (SCS) configuration between the SCS configuration of the PDCCH order and the SCS configuration of the corresponding PRACH transmission; Δ_{BWPSwitching}=0 if the active BWP does not change and Δ_{BWPSwitching} is defined in TS 38.133; otherwise, Δ_{Delay}=0.5 msec for frequency range (FR) 1 and Δ_{Delay}=0.25 msec for FR2; T_{switch} is a switching gap duration as defined in TS 38.214; and T_{switch2} is the RF switching time.

In some embodiments of the present disclosure, the processor is configured to switch back to the frequency of the serving cell after a last symbol of the PRACH transmission.

According to some embodiments of the present disclosure, the processor is configured to at least one of the following: be unexpected to be scheduled to transmit uplink transmission in the serving cell during a time duration, wherein the time duration starts from a last symbol of the PDCCH order, and ends no earlier than summation of the last symbol of the PRACH transmission and the RF switching time; suspend configured grant PUSCH transmission in the serving cell during the time duration; or drop all configured UL transmissions in the serving cell during the time duration.

According to some embodiments of the present disclosure, random access response (RAR) is configured for the PRACH transmission and is received in the serving cell, and a window for detecting the RAR in time division duplex (TDD) operation starts at a first symbol of an earliest control resource set (CORESET) where a UE is configured to receive PDCCH for Type1-PDCCH common search space (CSS) set, and is at least one symbol, after K orthogonal frequency division multiple access (OFDMA) symbols of the last symbol of the PRACH transmission, wherein the K OFDM symbols is summation of at least the RF switching time and a symbol duration corresponding to a SCS for Type1-PDCCH CSS set.

In some scenarios, the summation further includes a configured or predefined additional time, and the additional time is related to a time where the candidate cell sends a TA value to the serving cell.

According to some embodiments of the present disclosure, RAR is configured for the PRACH transmission and is received in the serving cell, and the processor is configured to retransmit the PRACH transmission no later than N_{T,1}+0.75+T_{switch2} msec after a last symbol of a window for detecting the RAR, or a last symbol of received physical downlink shared channel (PDSCH), wherein, N_{T,1} is a time duration of N₁ symbols corresponding to a PDSCH processing time for UE processing capability 1 assuming μ corresponds to a smallest SCS configuration among SCS configurations for a PDCCH carrying downlink control information (DCI) format 1_0, a corresponding PDSCH in the case of additional PDSCH demodulation reference signal (DMRS) being configured, and a corresponding PRACH transmission, and T_{switch2} is the RF switching time.

In some embodiments of the present disclosure, the processor is configured to switch back to the frequency of the serving cell after a last symbol of a PDSCH scheduled with random access (RA) radio network temporary identifier (RNTI) (RA-RNTI) corresponding to the PRACH transmission.

According to some embodiments of the present disclosure, the processor is configured to at least one of the following: be unexpected to be scheduled to transmit UL transmission in the serving cell during a time duration, wherein the time duration starts from a last symbol of the PDCCH order and ends no earlier than summation of a last symbol of a PDSCH scheduled by RA-RNTI corresponding to the PRACH transmission and the RF switching time; suspend configured grant PUSCH transmission in the serving cell during the time duration; or drop all configured UL transmissions in the serving cell during the time duration.

In some scenarios, in TDD operation, the processor is configured to: be unexpected to be scheduled to receive downlink (DL) in the serving cell during the time duration.

In some embodiments of the present disclosure, the processor is further configured to: determine whether to transmit the PRACH transmission in the case that the PRACH transmission including any interruption due to RF switching time is overlapped with an UL transmission in the serving cell or a cell set including the serving cell according to a predefined or configured rule; and transmit the PRACH transmission in the case that a priority of the PRACH transmission is higher than the UL transmission according to the predefined or configured rule.

According to some embodiments of the present disclosure, the UL transmission includes at least one of sounding reference signal (SRS), physical uplink control channel (PUCCH) or PUSCH.

According to some embodiments of the present disclosure, the predefined or configured rule defines that a priority of a PRACH transmission associated with a candidate cell, wherein a center frequency of SSB from the candidate cell is different from a center frequency of SSB from the serving cell, is higher than a UL transmission in the serving cell or a cell set including the serving cell.

According to some embodiments of the present disclosure, wherein, the predefined or configured rule defines that a priority of a PRACH transmission associated with a candidate cell, wherein a center frequency of SSB from the candidate cell is different from a center frequency of SSB from the serving cell the serving cell, is lower than a PUCCH or PUSCH transmission in the serving cell or the cell set including the serving cell, but higher than all other UL transmission except for the PUCCH or PUSCH transmission in the serving cell or the cell set including the serving cell.

In some scenarios, the PUSCH or PUCCH transmission is a PUCCH or PUSCH transmission carrying hybrid automatic repeat request-acknowledge (HARQ-ACK), positive schedule request (SR), rank indicator (RI), channel state information (CSI)-reference signal (RS) resource indicator CRI, or SS/PBCH block (SSB) resource indicator (SSBRI).

In some embodiments of the present disclosure, a first UL slot applying a TA value associated with the candidate cell is determined according to the RF switching time.

According to some embodiments of the present disclosure, SCS of the first UL slot is determined by a BWP of the candidate cell, and the first UL slot is after the reception of a cell switch command.

In some scenarios, the first UL slot applying the TA value is determined to an application time of the cell switch command, or according to both legacy specification and the cell switch command.

In some embodiments of the present disclosure, the RF switching time is max{switchingTimeUL, switchingTimeDL}, switchingTimeUL, or switchingTimeDL, where switchingTimeUL and switchingTimeDL are UL RF switching time and DL RF switching time respectively.

Some yet other embodiments of the present disclosure provide another wireless communication apparatus, e.g., a radio access network (RAN) node, which includes: a transceiver; and a processor coupled to the transceiver, wherein the processor is configured to: transmit, to a UE, from a serving cell on an active BWP, a PDCCH order triggering a PRACH transmission associated with a candidate cell of a set of candidate cells, wherein, the set of candidate cells is configured by higher layer, and a center frequency of SSB from the candidate cell is different from a center frequency of SSB from the serving cell; and receive, from the UE, the PRACH transmission to the candidate cell, wherein a time between a last symbol of the PDCCH order and a first symbol of the PRACH transmission is equal to or greater than a threshold timing gap, wherein the threshold timing gap is determined based on a RF switching time.

In some embodiments of the present disclosure, the threshold timing gap is: N_{T,2}+Δ_{BWPSwitching}+Δ_{Delay}+T_{switch}+T_{switch2} msec, where, N_{T,2} is a time duration of N₂ symbols corresponding to a physical uplink shared channel (PUSCH) preparation time for UE processing capability 1 assuming μ corresponds to a smallest subcarrier spacing (SCS) configuration between the SCS configuration of the PDCCH order and the SCS configuration of the corresponding PRACH transmission; Δ_{BWPSwitching}=0 if the active BWP does not change and Δ_{BWPSwitching} is defined in TS 38.133; otherwise, Δ_{Delay}=0.5 msec for frequency range (FR) 1 and Δ_{Delay}=0.25 msec for FR2; T_{switch} is a switching gap duration as defined in TS 38.214; and T_{switch2} is the RF switching time.

In some embodiments of the present disclosure, the UE is configured to switch back to the frequency of the serving cell after a last symbol of the PRACH transmission.

According to some embodiments of the present disclosure, the processor is configured to at least one of the following: stop scheduling the UE to transmit uplink transmission in the serving cell during a time duration, wherein the time duration starts from a last symbol of the PDCCH order, and ends no earlier than summation of the last symbol of the PRACH transmission and the RF switching time; or stop receiving any configured UL transmissions in the serving cell during the time duration.

According to some embodiments of the present disclosure, RAR is configured for the PRACH transmission and the processor is configured to transmit the RAR in the serving cell, and a window for transmitting the RAR in TDD operation starts at a first symbol of an earliest CORESET where a UE is configured to receive PDCCH for Type1-PDCCH CSS set, and is at least one symbol, after K OFDMA symbols of the last symbol of the PRACH transmission, wherein the K OFDM symbols is summation of at least the RF switching time and a symbol duration corresponding to a SCS for Type1-PDCCH CSS set.

According to some embodiments of the present disclosure, RAR is configured for the PRACH transmission, and the processor is configured to transmit the RAR in the serving cell, and to receive the PRACH transmission retransmitted no later than N_{T,1}+0.75+T_{switch2} msec after a last symbol of a window for transmitting the RAR, or a last symbol of received PDSCH, wherein, N_{T,1} is a time duration of N₁ symbols corresponding to a PDSCH processing time for UE processing capability 1 assuming μ corresponds to a smallest SCS configuration among SCS configurations for a PDCCH carrying DCI format 1_0, a corresponding PDSCH in the case of additional PDSCH DMRS being configured, and a corresponding PRACH transmission, and T_{switch2} is the RF switching time.

In some embodiments of the present disclosure, the UE is configured to switch back to the frequency of the serving cell after a last symbol of a PDSCH scheduled with RA-RNTI corresponding to the PRACH transmission.

According to some embodiments of the present disclosure, the processor is configured to at least one of the following: stop scheduling the UE to transmit UL transmission in the serving cell during a time duration, wherein the time duration starts from a last symbol of the PDCCH order and ends no earlier than summation of a last symbol of a PDSCH scheduled by RA-RNTI corresponding to the PRACH transmission and the RF switching time; or stop receiving any configured UL transmissions in the serving cell during the time duration.

According to some embodiments of the present disclosure, in TDD operation, the processor is configured to: stop scheduling the UE to receive DL in the serving cell during the time duration.

In some embodiments of the present disclosure, the processor is further configured to: determine whether to receive the PRACH transmission in the case that the PRACH transmission including any interruption due to RF switching time is overlapped with an UL transmission in the serving cell or a cell set including the serving cell according to a predefined or configured rule; and receive the PRACH transmission in the case that a priority of the PRACH transmission is higher than the UL transmission according to the predefined or configured rule.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system in accordance with aspects of the present disclosure.

FIG. 2 illustrates a flow chart of a method of supporting TA acquisition in accordance with aspects of the present disclosure.

FIG. 3 illustrates a block diagram of an apparatus of supporting TA acquisition in accordance with aspects of the present disclosure.

FIG. 4 illustrates a block diagram of an apparatus of supporting TA acquisition in accordance with aspects of the present disclosure.

### DETAILED DESCRIPTION

When L1/L2 based inter-cell mobility is configured for UE, TA will be acquired for a candidate cell before cell switch. If the candidate cell is an inter-frequency candidate cell, the UE needs to switch RF from that of the serving cell to the candidate cell to transmit PRACH to the candidate cell. However, legacy TA acquisition technique does not consider RF switching at all, and thus cannot be applied to L1/L2 based inter-cell mobility.

Thus, embodiments of the present disclosure provide a technical solution of supporting TA acquisition in L1/L2-triggered mobility scenarios, including but not limited to: TA acquisition of an inter-frequency candidate cell, UE behaviors after the PRACH transmission to the inter-frequency candidate cell or before UE switching RF back to that of the serving cell, determination of the starting of RAR window and the PRACH retransmission timing if RAR is supported or configured in the serving cell for the PRACH transmission, and the application time of the TA value associated with the inter-frequency candidate cell etc.

By considering RF switching time, TA acquisition disclosed in the present disclosure can be used in L1/L2-triggered mobility scenarios, which can reduce mobility latency. Accordingly, the present disclosure can facilitate and improve the implementation of NR.

FIG. 1 illustrates a schematic diagram of an exemplary wireless communication system 100 in accordance with aspects of the present disclosure.

As shown in FIG. 1, the wireless communication system 100 includes a UE 103 and a base station (BS) 101. Although merely one BS is illustrated in FIG. 1 for simplicity, it is contemplated that the wireless communication system 100 may include more BSs in some other embodiments of the present disclosure. Similarly, although merely one UE is illustrated in FIG. 1 for simplicity, it is contemplated that the wireless communication system 100 may include more UEs in some other embodiments of the present disclosure.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one transmit-receive point (TRP) (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

The UE 103 may move among different cells. Conventionally, serving cell change is performed by explicit radio resource control (RRC) reconfiguration signaling to trigger the synchronization of target cell based on layer 3 (L3) measurements report. In 3GPP Rel-18, a new work item on further NR mobility enhancements is approved to enable a serving cell change via lower layer signaling, e.g., L1 or L2 signaling, in order to reduce the latency, overhead and interruption time.

For example, in Rel-18 L1/L2-triggered mobility, TA enhancement for inter-cell cases will be studied. It is agreed that inter-frequency measurement is supported where the inter-frequency measurement is for cell switching to a candidate cell which is in inter-frequency with the serving cell (i.e., an inter-frequency candidate cell). Different from intra-frequency, which means that the same frequency is used for a serving cell and a candidate cell, inter-frequency means that different frequencies are used for a serving cell and a candidate cell. For example, a center frequency of SSB from the candidate cell is different from a center frequency of SSB from the serving cell. Such a candidate cell is also called inter-frequency cell. Although according to Rel-18 L1/L2 mobility, RAN1 will further study the potential RAN1 spec impact of L1 inter-frequency measurement, the definition and scenarios of L1 inter-frequency measurement is determined by RAN4. Thus, RAN1 assumes at least the following until receiving RAN4's confirmation:
V The scenarios not included in intra-frequency are regarded as inter-frequency, which includes at least the following scenarios:
   The frequency of the measured RS not covered by any of the active BWPs of SpCell and Scells configured for a UE, but covered by some of the configured BWPs of SpCell and Scells configured for a UE.
   The frequency of the measured RS not covered by any of the configured BWPs of SpCell and Scells configured for a UE.

In order to obtain the TA of the inter-frequency candidate cell, a RACH procedure will be triggered (or initiated) by a PDCCH order which is for the inter-frequency candidate cell. According to legacy specification(s) (e.g., TS38.213), a threshold timing gap between the PDCCH order and a PRACH transmission triggered by the PDCCH order is specified. However, in the scenarios of L1/L2 based inter-cell mobility, after receiving the PDCCH order triggering the PRACH transmission associated with the inter-frequency candidate cell, UE needs to switch (or tune or retune) the RF (or frequency, or band etc.) to transmit the PRACH transmission (PRACH preamble or PRACH resource or PRACH etc.) to the inter-frequency candidate cell. Thus, the legacy threshold timing gap between the PDCCH order and the PRACH transmission cannot be applied in the scenarios of L1/L2 based inter-case mobility.

Similarly, there are other issues caused by RF switching or retuning between the serving cell and the inter-frequency candidate cell need to be solved in the scenarios of L1/L2 based inter-cell mobility.

For example, due to RF switching to the frequency (or band) of the inter-frequency candidate cell, the UL and/or DL transmission in the serving cell may be stopped or suspended. In order to reduce the impact of UL and/or DL transmission in the serving cell, UE needs to switch the RF back to the frequency of the serving cell after transmitting the PRACH transmission as soon as possible. Thus, the timing of RF switching back should also be specified, which is related to whether RAR is supported or configured for the RACH procedure associated with the inter-frequency candidate cell and where the RAR is transmitted.

Besides, if RAR is configured while is transmitted in the serving cell in scenarios of L1/L2 based inter-cell mobility, UE needs a time to retune the RF back to that of the serving cell to receive the RAR in TDD operation. Therefore, the window for detecting or receiving the RAR (also referred to as RAR window) should also be enhanced in scenarios of L1/L2 based inter-cell mobility. Besides, the timing of retransmitting the PRACH should also be solved because the UE needs to switch the RF to the frequency of the inter-frequency candidate cell for retransmission.

In addition, UE behaviours before UE switches the RF back to the frequency of the serving cell from that of the inter-frequency candidate cell or after transmitting the PRACH is also unclear for persons skilled in the art, which needs to be determined.

Furthermore, the TA value of the inter-frequency candidate cell may be indicated by the serving cell, while the TA value can only be applied for the inter-frequency candidate cell. That is, there is a RF switching time (or RF retuning time, or RF tuning time etc.) between the TA indication (or, TA value/command indication etc.) and the TA application time (or TA value/command application time) too. However, the legacy technology for determining the TA application time is not applicable in the scenarios of L1/L2 based inter-cell mobility either.

At least for solving the above technical problems, embodiments of the present disclosure provide a technical solution of supporting TA acquisition, e.g., a method and apparatus of supporting TA acquisition in L1/L2 based inter-cell mobility scenarios.

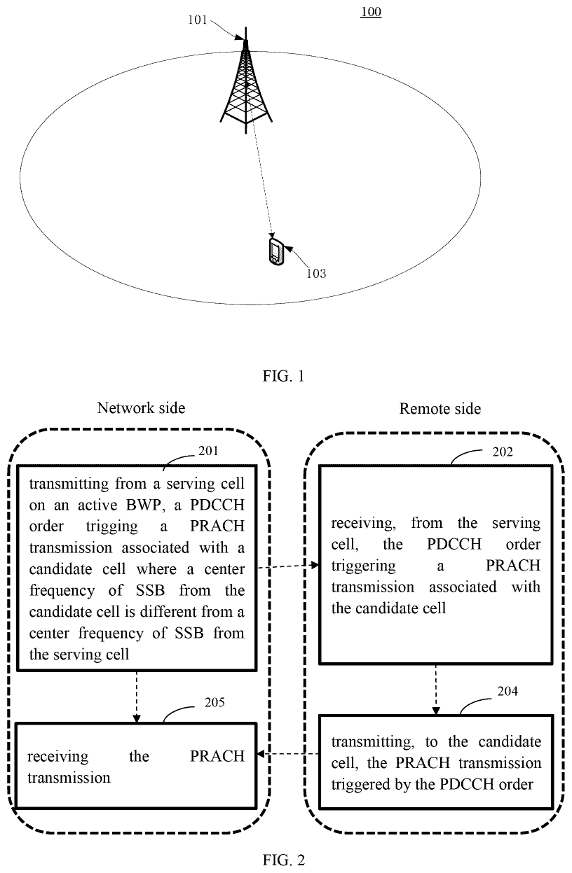

FIG. 2 illustrates a flow chart of a method of supporting TA acquisition in accordance with aspects of the present disclosure. Although the method is illustrated in a system level by a wireless communication apparatus in a remote side (or UE side), e.g., UE and a wireless communication apparatus in a network side (or RAN side), e.g., a RAN node (e.g., a gNB etc.), persons skilled in the art can understand that the method implemented in the remote side and that implemented in the network side can be separately implemented and incorporated by other apparatus with similar functions. In addition, no transmission or reception failure is considered in the illustrated embodiments of the present disclosure.

In some scenarios, a RAN node is in a central unit (CU)-distributed unit (DU) split based RAN architecture. Accordingly, the internal structure of the RAN node, e.g., BS 101 as shown in FIG. 1 may be split into a CU and at least one DU (not shown). Potential applicable scenarios of L1/L2 triggered mobility (LTM) may include intra-CU intra-DU mobility (also referred to as intra-DU mobility) and intra-CU inter-DU mobility (also referred to as inter-DU mobility). In the scenarios of intra-CU intra-DU, UE will move between different cells within a DU. In the scenarios of intra-CU inter-DU, UE will move between different cells belonging to different DUs but within a CU. Persons skilled in the art would clearly determine the communication between the UE and the wireless communication apparatus(s) in the network side in different L1/L2 triggered mobility scenarios under the disclosure and teaching of the illustrated embodiments of the present disclosure.

Referring to FIG. 2, a UE in a serving cell can be configured in L1/L2 based inter-cell mobility scenarios by a RRC signaling or other manners. For example, one or more signalling, e.g., RRC signalling, may be used to indicate whether a UE is configured with L1/L2-triggered mobility for TA acquisition of a candidate cell (or an additional physical cell identifier (PCI)). In addition, if a configuration or a parameter, e.g., a RRC parameter (e.g., “L1/L2Mobility” or the like) which means L1/L2-triggered mobility is configured in a serving cell, is configured in a serving cell, it will be identified as L1/L2-triggered mobility.

For the UE in L1/L2 based inter-cell mobility scenarios, a set of candidate cells will be configured for the UE by higher layer, e.g., RRC layer or a layer higher than RRC. Before switching from the serving cell to a candidate cell of the set of candidate cells, TA will be acquired for the candidate cell. The set of candidate cells may include one or more intra-frequency candidate cells and/or one or more inter-frequency candidate cells. If the frequency of a candidate cell and the frequency of the serving cell are inter-frequency, then the UE needs to switch the RF to the frequency of the inter-frequency candidate cell to transmit PRACH for the inter-frequency candidate cell for TA acquisition. Herein, only TA acquisition for inter-candidate cell and related operations in the UE side and network side will be illustrated, and thus the candidate cell used for simplification in the following will refer to the inter-frequency candidate cell.

Specifically, in step 201, the RAN node, e.g., a gNB may transmit a PDCCH order from the serving cell on an active BWP to the UE. The PDCCH order will trigger a PRACH transmission (or a RACH procedure) associated with a candidate cell where a center frequency of SSB from the candidate cell is different from a center frequency of SSB from the serving cell of the set of candidate cells from the UE. Accordingly, the UE will receive the PDCCH order, from the serving cell in step 202.

In response to the received PDCCH order, the UE will transmit, to the candidate cell, the PRACH transmission triggered by the PDCCH order in step 204. Accordingly, the RAN node will receive the PRACH transmission to the candidate cell in step 205. Based on the PRACH transmission, the TA value of the candidate cell will be calculated in the network side.

It is known that there is a timing limitation for PRACH transmission triggered by the PDCCH order, where the threshold timing gap between the PDCCH order and the PRACH transmission is determined for the PRACH transmission triggered by PDCCH order according to legacy specification, e.g., TS38.213. However, for a PRACH transmission to an inter-frequency candidate cell (a center frequency of SSB from the candidate cell is different from a center frequency of SSB from the serving cell), the UE needs to switch RF from that of the serving cell for transmitting the PRACH. Thus, according to some embodiments of the present disclosure, the threshold timing gap between the PDCCH order and the PRACH transmission triggered by the PDCCH order will include the RF switching time. The time between the last symbol of the PDCCH order and the first symbol of the PRACH transmission is equal to or greater than (that is, no later than) the threshold timing gap determined based on the RF switching time. An exemplary RF switching time is max{switchingTimeUL, switchingTimeDL}, switchingTimeUL, or switchingTimeDL, wherein, switchingTimeUL and switchingTimeDL are UL RF switching time and DL RF switching time respectively.

For example, based on the RF switching time, an enhanced threshold timing gap is: N_{T,2}+Δ_{BWPSwitching}+Δ_{Delay}+T_{switch}+T_{switch2} msec, where,
N_{T,2} is a time duration of N₂ symbols corresponding to a PUSCH preparation time for UE processing capability 1 (e.g., see TS 38.214) assuming μ corresponds to a smallest SCS configuration between the SCS configuration of the PDCCH order and the SCS configuration of the corresponding PRACH transmission;
Δ_{BWPSwitching}=0 if the active BWP does not change and Δ_{BWPSwitching} is defined in TS 38.133; otherwise,
Δ_{Delay}=0.5 msec for FR1 and Δ_{Delay}=0.25 msec for FR2;
T_{switch} is a switching gap duration as defined in TS 38.214; and
T_{switch2} is the RF switching time.

For a PRACH transmission using 1.25 kHz or 5 kHz SCS, the UE will determine N₂ assuming SCS configuration μ=0. Since the active BWP is not changed during the PRACH transmission to the inter-frequency candidate cell, Δ_{BWPSwitching} will always be 0.

After transmitting the PRACH transmission, the UE needs to switch the RF back, that is, to that of the serving cell. However, when (or the timing, or the time) the UE will switch back to the frequency of the serving cell has not been clearly determined in legacy technology. In addition, whether RAR (e.g., PDCCH RAR and PDSCH RAR) is needed for PDCCH ordered RACH for a candidate cell in L1/L2 triggered mobility has not settled yet. It is only agreed that the following alternatives are considered for further study: Alt 1: RAR is needed; Alt 2: RAR is not needed (Note: If Alt 2 is supported, TA value of candidate cell is indicated in cell switch command); and Alt 3: whether RAR is needed can be configured.

Thus, there are various manners of determination timing of RF switching back to the serving cell according to some embodiments of the present disclosure. For example, in some embodiments of the present disclosure, the UE is expected to switch back to the frequency of the serving cell after the last symbol of the PRACH transmission (Cases 1). In some other embodiments of the present disclosure, the UE is expected to switch back to the frequency of the serving cell after the last symbol of a PDSCH scheduled with RA-RNTI (PDSCH RAR) corresponding to the PRACH transmission (Cases 2). UE behaviors will also be various depending on the timing of RF switching back to the serving cell.

Regarding the UL transmission and DL transmission which may be affected by the RF switch to transmit the PRACH transmission (before and/or after the PRACH transmission), embodiments of the present disclosure illustrate different schemes in Cases 1 and Cases 2. These illustrated embodiments may also be applied to other cases related to timing of RF switch back to the serving cell according to some embodiments of the present disclosure.

### Cases 1

In Cases 1, the UE is expected to switch back to the frequency of the serving cell after the last symbol of the PRACH transmission. Transmission (or reception) by the UE in the serving cell will consider the RF switching time, e.g., at least from the first symbol which is at least the RF retuning time after the last symbol of the PRACH transmission.

In some embodiments of the present disclosure (Scheme 1-1), a time duration based on the RF switching time will be applied to limit the UL and DL transmission (if any). An exemplary time duration starts from the last symbol of the PDCCH order, and ends no earlier than the summation of the last symbol of the PRACH transmission and the RF retuning time (sum time length or duration of the last symbol of the PRACH transmission and the RF retuning time).

Regarding the UL transmission (in the perspective of the UE side) in Cases 1, according to some embodiments under Scheme 1-1 of the present disclosure, the network side will not schedule the UE to transmit UL transmission during the time duration, that is, the UE is not expected to be scheduled to transmit UL transmission in the serving cell during the time duration. The UE will suspend the configured grant PUSCH transmission (if any) in the serving cell during the time duration. All the configured UL transmissions (if any, e.g., periodic PUCCH, PUCCH for semi-persistent CSI reports, PUSCH for semi-persistent CSI reports, periodic SRS, and semi-persistent SRS etc.) in the serving cell will be dropped (that is, will not be transmitted) during the time duration. Accordingly, the network side will not receive the UL transmission during the time duration, e.g., due to no UL transmission being scheduled, or UL transmission being suspended or dropped or the like.

In Cases 1, RAR will not be supported or configured for the RACH procedure associated with the inter-frequency candidate cell or RAR associated with the inter-frequency candidate cell will be transmitted in the serving cell. Whatever, for TDD operation (DL) in Cases 1, according to some embodiments under Scheme 1-1 of the present disclosure, the network side will not transmit Dl or schedule the UE to receive DL (if any, or DL transmission in the perspective of the network side) during the time duration, that is, the UE is not expected to be scheduled to receive DL in the serving cell during the time duration.

In some other embodiments of the present disclosure (Scheme 1-2), a configured or predefined rule is proposed to determine whether to transmit the PRACH transmission in the case that the PRACH transmission including any interruption due to the RF switching time is overlapped with a UL transmission in the serving cell or a cell set including the serving cell. The UL transmission may be PUCCH, PUSCH and/or SRS etc. An exemplary predefined or configured rule may define that the priority of a PRACH transmission associated with an inter-frequency candidate cell is higher than a UL transmission in the serving cell or the cell set including the serving cell. Another exemplary predefined or configured rule may define that the priority of a PRACH transmission associated with an inter-frequency candidate cell is lower than a PUCCH or PUSCH transmission in the serving cell or the cell set including the serving cell, but higher than all other UL transmission except for the PUCCH or PUSCH transmission in the serving cell or the cell set including the serving cell. More detailed embodiments under Scheme 1-2 are illustrated below.

Specifically, in some scenarios, a UL transmission in the serving cell or the cell set including the serving cell, which will be affected by the RF switch for PRACH transmission for the inter-frequency candidate cell, is overlapped with the PRACH transmission associated with inter-frequency candidate cell in at least one symbol. The PRACH transmission includes any interruption due to the RF switching time, e.g., UL or DL RF switching time as defined by higher layer parameters switchingTimeUL and switchingTimeDL or the like. Then, the UE will determine whether to transmit the PRACH transmission or UL transmission. Accordingly, the network side will determine whether to receive the PRACH transmission or UL transmission based on the priority rule.

PRACH transmission in the inter-frequency candidate cell and PRACH transmission in the serving cell or the cell set including the serving cell which will be affected by the RF switch for PRACH transmission for the inter-frequency candidate cell may be overlapped in some scenarios. Then, before the priority determination between the overlapped PRACH transmission and UL transmission (if any), it is up to UE implementation to select one PRACH to be transmitted from the overlapped PRACH transmissions in the inter-frequency candidate cell and the serving cell or the cell set including the serving cell. If the PRACH transmission in the inter-frequency candidate cell is selected while still is overlapped with the UL transmission in the serving cell or the cell set including the serving cell, then whether the PRACH transmission in the inter-frequency candidate cell will be transmitted or not will be determined.

According to some embodiments of the present disclosure, the priority of the PRACH transmission associated with the inter-frequency candidate cell is always higher than a UL transmission (e.g., PUCCH, PUSCH and/or SRS etc.) in the serving cell or the cell set including the serving cell which will be affected by the RF switch for PRACH transmission for the inter-frequency candidate cell. In the at least one overlapped symbol, the UE will transmit the PRACH transmission associated with the inter-frequency candidate cell, while will not transmit the overlapped UL transmission in the serving cell or the cell set including the serving cell.

According to some other embodiments of the present disclosure, the priority of the PRACH transmission associated with the inter-frequency candidate cell is lower than PUSCH or PUCCH transmission in the serving cell or the cell set including the serving cell which will be affected by the RF switch for PRACH transmission associated with the inter-frequency candidate cell, but higher than all other UL transmissions except for PUSCH or PUCCH transmission in the serving cell or the cell set including the serving cell. The PUSCH or PUCCH transmission in the serving cell or the cell set including the serving cell which has the higher priority than the PRACH transmission associated with the inter-frequency candidate cell may be limited to some specific UL transmissions, e.g., PUCCH or PUSCH transmission carrying HARQ-ACK, positive SR, RI, CRI, and/or SSBRI etc.

For example, the PUSCH or PUCCH transmission carrying HARQ-ACK, positive SR, RI, CRI and/or SSBRI in the serving cell or the cell set including the serving cell which will be affected by the RF switch for PRACH transmission for the inter-frequency candidate cell is overlapped with the PRACH for the inter-frequency candidate cell in at least one symbol. Then, the UE will transmit the PUSCH or PUCCH transmission carrying HARQ-ACK, positive SR, RI, CRI and/or SSBRI in the serving cell or the cell set including the serving cell, but will not transmit the PRACH for the inter-frequency candidate cell in the at least one overlapped symbol according to the priority rule. The UE will not switch the RF to that of the inter-frequency candidate cell because the PRACH transmission associated with the inter-frequency candidate cell will not be transmitted.

For another example, the PRACH transmission for the inter-frequency candidate cell is overlapped with the UL transmission except for PUSCH or PUCCH transmission carrying HARQ-ACK, positive SR, RI, CRI and/or SSBRI (hereafter, other UL transmission) in the serving cell or the cell set including the serving cell which will be affected by the RF switch for PRACH transmission for the inter-frequency candidate cell in the at least one symbol. Then, the UE will switch the RF to that of the inter-frequency candidate cell and transmit the PRACH transmission for the inter-frequency candidate cell in the at least one overlapped symbol, but not transmit the other UL transmission in the serving cell or the cell set including the serving cell.

In addition, under Scheme 1-1 or 1-2 of the present disclosure, RAR may be supported or configured for the RACH procedure associated with the inter-frequency candidate cell (where a center frequency of SSB from the candidate cell is different from a center frequency of SSB from the serving cell) while is transmitted from the serving cell. The UE will work in TDD operation to receive the RAR. Exemplary RAR in response to PRACH transmission, e.g., PDCCH RAR is PDCCH (DCI format 1_0) with cyclic redundancy check (CRC) scrambled by RA-RNTI or MSGB-RNTI. In other words, an exemplary RAR is PDCCH with DCI format 1_0 and CRC scrambled by RA-RNTI in response to a PRACH transmission.

The UE will switch the RF back to that of the serving cell for DL, where the RF switching time will be considered for the RAR window for TDD operation to at least enhance RAR monitoring in UE side. In some embodiments of the present disclosure, if the UE does not receive RAR within the RAR window corresponding to the PRACH associated with the inter-frequency candidate cell (where a center frequency of SSB from the candidate cell is different from a center frequency of SSB from the serving cell), the PRACH will be retransmitted. The UE will switch the RF to the frequency of the inter-frequency candidate cell (where a center frequency of SSB from the candidate cell is different from a center frequency of SSB from the serving cell) to retransmit the PRACH, where the RF switching time will also be considered for the timing determination of the PRACH retransmission.

Some embodiments of the present disclosure provide the timing determination of the RAR window for TDD operation, while no PRACH retransmission for the inter-frequency candidate cell (where a center frequency of SSB from the candidate cell is different from a center frequency of SSB from the serving cell) is considered. An exemplary RAR window will start at the first symbol of the earliest CORESET where the UE is configured to receive PDCCH for Type1-PDCCH CSS set. In other word, an exemplary RAR window is at least one symbol, after a time duration, e.g., K OFDM symbols of the last symbol of the PRACH transmission for the inter-frequency candidate cell (where a center frequency of SSB from the candidate cell is different from a center frequency of SSB from the serving cell). An exemplary time duration, e.g., K OFDM symbols, is summation of at least the RF switching time and one symbol duration corresponding to the SCS for Type1-PDCCH CSS set, that is, a time duration at least including the RF switching time and one symbol duration corresponding to the SCS for Type1-PDCCH CSS set. In some scenarios, the time duration will further include an additional time, which can be configured, e.g., by RRC signaling or predefined. The additional time is related to the time where the inter-frequency candidate cell (where a center frequency of SSB from the candidate cell is different from a center frequency of SSB from the serving cell) sends the calculated TA value according to the received PRACH to the serving cell by the linkage between the inter-frequency candidate cell (where a center frequency of SSB from the candidate cell is different from a center frequency of SSB from the serving cell) and the serving cell. In the case that the additional time is considered, while the additional time is not configured or predefined, the additional time will be deemed as zero.

Some embodiments of the present disclosure provide the timing of PRACH retransmission associated with the inter-frequency candidate cell. For example, when the UE needs to retransmit the PRACH for the inter-frequency candidate cell (where a center frequency of SSB from the candidate cell is different from a center frequency of SSB from the serving cell) which means UE does not detect a corresponding RAR within the RAR window, the UE needs to be ready to transmit the PRACH no later than N_{T,1}+0.75+T_{switch2} msec after the last symbol of the RAR window, or the last symbol of the PDSCH reception. Similarly, N_{T,1} is a time duration of N₁ symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the UE assumes N_{1,0}=14 (e.g., see TS 38.214). T_{switch2} is the RF switching time. For a PRACH transmission using 1.25 kHz or 5 kHz SCS, the UE determines N₁ assuming SCS configuration μ=0.

### Cases 2

In Cases 2, RAR will be supported or configured for RACH procedure associated with the inter-frequency candidate cell (where a center frequency of SSB from the candidate cell is different from a center frequency of SSB from the serving cell), where the common search space for PDCCH RAR which is Type1-CSS set is configured in the inter-frequency candidate cell but not the serving cell. Since the RAR is transmitted from the inter-frequency candidate cell (where a center frequency of SSB from the candidate cell is different from a center frequency of SSB from the serving cell), UE will switch the RF back to that of the serving cell after receiving the RAR in the inter-frequency candidate cell (where a center frequency of SSB from the candidate cell is different from a center frequency of SSB from the serving cell). For example, UE will switch the RF back to that of the serving cell after the last symbol of a PDSCH scheduled with RA-RNTI (e.g., PDSCH RAR) corresponding to the PRACH transmission associated with inter-frequency candidate cell (where a center frequency of SSB from the candidate cell is different from a center frequency of SSB from the serving cell).

Similarly, transmission (or reception) by the UE in the serving cell will consider the RF switching time, e.g., at least from the first symbol which is at least the RF switching time after the last symbol of a PDSCH scheduled with RA-RNTI (e.g., PDSCH RAR) corresponding to the PRACH transmission associated with inter-frequency candidate cell.

In some embodiments of the present disclosure (Scheme 2-1), a time duration based on the RF switching time will be applied to limit the UL and DL transmission (if any) similar to Scheme 1-1 in Cases 1. An exemplary time duration will start from the last symbol of the PDCCH order and end no earlier than the summation of the last symbol of a PDSCH scheduled by RA-RNTI corresponding to the PRACH transmission and the RF switching time.

Regarding the UL transmission (in the perspective of the UE side) in Cases 2, according to some embodiments under Scheme 2-1 of the present disclosure, the network side will not schedule the UE to transmit UL in the serving cell, that is, the UE is not expected to be scheduled to transmit UL in the serving cell during the time duration. The UE will suspend the configured grant PUSCH transmission (if any) in the serving cell during the time duration. All the configured UL transmissions (if any, e.g., periodic PUCCH, PUCCH for semi-persistent CSI reports, PUSCH for semi-persistent CSI reports, periodic SRS, and semi-persistent SRS etc.) in the serving cell will be dropped (that is, will not be transmitted) during the time duration. Accordingly, the network side will not receive the UL transmission during the time duration, e.g., due to no UL transmission being scheduled, or UL transmission being suspended or dropped or the like.

For TDD operation under Scheme 2-1, the network side will not transmit DL or schedule the UE to receive DL (if any, or DL transmission in the perspective of the network side) during the time duration, that is, the UE is not expected to be scheduled to receive DL in the serving cell during the time duration.

In addition, regarding the UL transmission (in the perspective of the UE side) in Cases 2, a scheme identical with or similar to Scheme 1-2 illustrated in Cases 1 can also be applied, and will not repeat herein.

In the case that the TA associated with the inter-frequency candidate cell (where a center frequency of SSB from the candidate cell is different from a center frequency of SSB from the serving cell) (by the PRACH transmission or retransmission) is acquired in the UE side, the application time (or timing) of TA value needs to be determined. An exemplary TA value may be indicated by a cell switch command or a RAR.

According to the legacy specification (related contents are reproduced below), the application timing of TA value is related to DL and UL processing delay time, MAC processing delay time, and max TA value.
“For a timing advance command received on uplink slot n and for a transmission other than a PUSCH scheduled by a RAR UL grant or a fallbackRAR UL grant as described in clause 8.2A or 8.3, or a PUCCH with HARQ-ACK information in response to a successRAR as described in clause 8.2A, the corresponding adjustment of the uplink transmission timing applies from the beginning of uplink slot n+k+1+2^{μ}·K_{offset} where

$$k = ⌈ {N}_{slot}^{subframe , μ} \cdot$$

(N_{T,1}+N_{T,2}+N_{TA,max}+0.5)/T_{sf}, N_{T,1} is a time duration in msec of N₁ symbols corresponding to a PDSCH processing time for UE processing capability 1 when additional PDSCH DM-RS is configured, N_{T,2} is a time duration in msec of N₂ symbols corresponding to a PUSCH preparation time for UE processing capability 1 [6, TS 38.214], N_{TA,max} is the maximum timing advance value in msec that can be provided by a TA command field of 12 bits,

$${N}_{slot}^{subframe , μ}$$

is the number of slots per subframe, T_{sf} is the subframe duration of 1 msec, and K_{offset}=K_{cell,offset}−K_{UE,offset}, where K_{cell,offset} is provided by CellSpecific_K_{offset} and K_{UE,offset} is provided by a Differential K_{offset} MAC CE command [11, TS 38.321]; otherwise, if not respectively provided, K_{cell,offset}=0 or K_{UE,offset}=0. N₁ and N₂ are determined with respect to the minimum SCS among the SCSs of all configured UL BWPs for all uplink carriers in the TAG and of all configured DL BWPs for the corresponding downlink carriers. For μ=0, the UE assumes N_{1,0}=14 [6, TS 38.214]. Slot n and

$${N}_{slot}^{subframe , μ}$$

are determined with respect to the minimum SCS among the SCS's of all configured UL BWPs for all uplink carriers in the TAG. N_{TA,max} is determined with respect to the minimum SCS among the SCSs of all configured UL BWPs for all uplink carriers in the TAG and for all configured initial UL BWPs provided by initialUplinkBWP. The uplink slot n is the last slot among uplink slot(s) overlapping with the slot(s) of PDSCH reception assuming T_{TA}=0, where the PDSCH provides the timing advance command and T_{TA} is defined in [4, TS 38.211].”

Thus, there is no RF switching time to be considered in legacy specification. However, according to some embodiments of the present disclosure, the RF switching time will be considered when determining the application timing of TA value calculated by the inter-frequency candidate cell (where a center frequency of SSB from the candidate cell is different from a center frequency of SSB from the serving cell) according to the PRACH transmission. That is, the first UL slot applying the TA value of the inter-frequency candidate cell (where a center frequency of SSB from the candidate cell is different from a center frequency of SSB from the serving cell) in the UE side is determined at least according to the RF switching time in the scenario of L1/L2 based inter-cell mobility.

For example, the first UL slot whose SCS is determined by the BWP of the inter-frequency candidate cell applying the TA value is X ms after the reception of the cell switch command, where X is determined by the RF switching time. The first UL slot applying the TA value may be only determined to the application time of the cell switch command, or both of the application time of TA according to legacy specification (legacy application of TA) and the cell switch command. For example, in the case that the first UL slot applying the TA value is determined according to both the legacy application time of TA and the cell switch command, the determined application time of the TA of the inter-frequency candidate cell (where a center frequency of SSB from the candidate cell is different from a center frequency of SSB from the serving cell) may be the maximum of the legacy application time of TA and the cell switch command. Regardless of the detailed determination of the first UL slot applying the TA value associated with the inter-frequency candidate cell mobility, the RF switching time will always be included for the determination of the first UL slot applying the TA value.

In addition, persons skilled in the art should well know that although some configurations and/or parameters, e.g., “switchingTimeUL,” and “switchingTimeDL” etc. are common known in legacy specifications, they may evolve into other terms as the evolution of 3GPPP. Thus, the name of such configurations and/or parameters should not be used to unduly limit the scope of the present disclosure, and should be reasonably interpreted with their technical substance. In addition, although some embodiments are illustrated in view of only one side, e.g., the network side or the remote side, persons skilled in the art would clearly determine how to consistently apply the technical solutions in the other side based on the consistency between the network side and remote side.

Besides the methods, embodiments of the present disclosure also propose an apparatus of supporting TA acquisition.

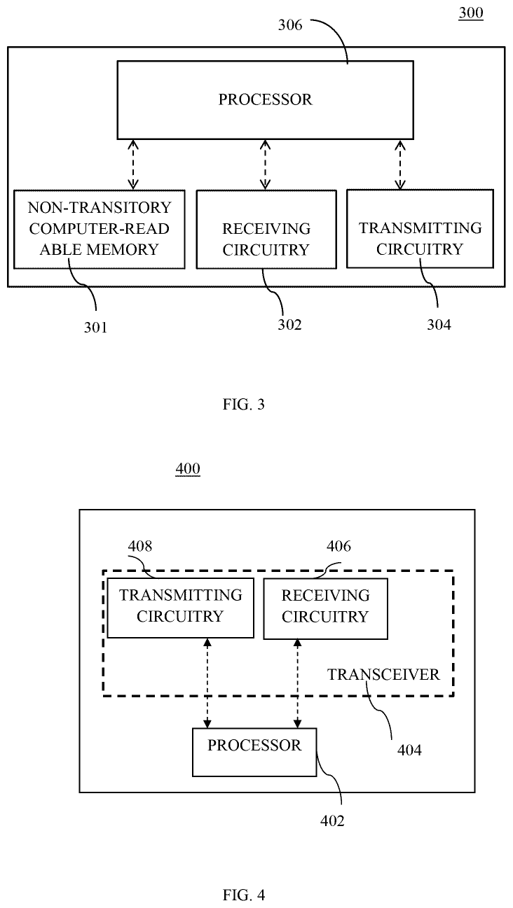

For example, FIG. 3 illustrates a block diagram of an apparatus 300 of supporting TA acquisition in accordance with aspects of the present disclosure.

As shown in FIG. 3, the apparatus 300 may include at least one non-transitory computer-readable medium 301, at least one receiving circuitry 302, at least one transmitting circuitry 304, and at least one processor 306 coupled to the non-transitory computer-readable medium 301, the receiving circuitry 302 and the transmitting circuitry 304. The at least one processor 306 may be a central processing unit (CPU), a digital signaling processing (DSP), a microprocessor etc. The apparatus 300 may be a wireless communication apparatus in the network side (e.g., a RAN node) or in the remote side (e.g., a UE) configured to perform a method illustrated in the above or the like.

Although in this figure, elements such as the at least one processor 306, transmitting circuitry 304, and receiving circuitry 302 are described in the singular, the plural is contemplated unless a limitation to the singular is explicitly stated. In some embodiments of the present disclosure, the receiving circuitry 302 and the transmitting circuitry 304 can be combined into a single device, such as a transceiver. In certain embodiments of the present disclosure, the apparatus 300 may further include an input device, a memory, and/or other components.

In some embodiments of the present disclosure, the non-transitory computer-readable medium 301 may have stored thereon computer-executable instructions to cause a processor to implement the method with respect to the wireless communication apparatus in the network side, e.g., the gNB as described above. For example, the computer-executable instructions, when executed, cause the processor 306 interacting with receiving circuitry 302 and transmitting circuitry 304, so as to perform the steps with respect to the wireless communication apparatus in the network side as depicted above.

In some embodiments of the present disclosure, the non-transitory computer-readable medium 301 may have stored thereon computer-executable instructions to cause a processor to implement the method with respect to the wireless communication apparatus in the remote side, e.g., the UE as described above. For example, the computer-executable instructions, when executed, cause the processor 306 interacting with receiving circuitry 302 and transmitting circuitry 304, so as to perform the steps with respect to the wireless communication apparatus in the remote side as illustrated above.

FIG. 4 is a block diagram of an apparatus 400 of beam determination in accordance with aspects of the present disclosure.

Referring to FIG. 4, the apparatus 400, for example a wireless communication apparatus in the network side or in remote side may include at least one processor 402 and at least one transceiver 404 coupled to the at least one processor 402. The transceiver 404 may include at least one separate receiving circuitry 406 and transmitting circuitry 408, or at least one integrated receiving circuitry 406 and transmitting circuitry 408. The at least one processor 402 may be a CPU, a DSP, a microprocessor etc.

According to some embodiments of the present disclosure, the apparatus 400 is a wireless communication apparatus in the network side, e.g., a gNB, which includes: a transceiver; and a processor coupled to the transceiver, wherein the processor is configured to: transmit, to a UE, from a serving cell on an active BWP, a PDCCH order triggering a PRACH transmission associated with a candidate cell of a set of candidate cells, wherein, the set of candidate cells is configured by higher layer, and a center frequency of SSB from the candidate cell is different from a center frequency of SSB from the serving cell; and receive, from the UE, the PRACH transmission to the candidate cell, wherein a time between a last symbol of the PDCCH order and a first symbol of the PRACH transmission is equal to or greater than a threshold timing gap, wherein the threshold timing gap is based on a RF switching time.

According to some embodiments of the present disclosure, the apparatus 400 is a wireless communication apparatus in the remote side, e.g., a UE, which includes: a transceiver; and a processor coupled to the transceiver, wherein the processor is configured to: receive, from a serving cell on an active BWP, a PDCCH order triggering a PRACH transmission associated with a candidate cell of a set of candidate cells, wherein the set of candidate cells is configured by higher layer, and a center frequency of SSB from the candidate cell is different from a center frequency of SSB from the serving cell; and transmit, to the candidate cell, the PRACH transmission, wherein a time between a last symbol of the PDCCH order and a first symbol of the PRACH transmission is equal to or greater than a threshold timing gap, wherein the threshold timing gap is based on a RF switching time.

The method according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present disclosure provides an apparatus, including a processor and a memory. Computer programmable instructions for implementing a method are stored in the memory, and the processor is configured to perform the computer programmable instructions to implement the method. The method may be a method as stated above or other method according to an embodiment of the present disclosure.

An alternative embodiment preferably implements the methods according to embodiments of the present disclosure in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present disclosure provides a non-transitory, computer-readable storage medium having computer programmable instructions stored therein. The computer programmable instructions are configured to implement a method as stated above or other method according to an embodiment of the present disclosure.

The detailed description of the appended drawings is intended as a description of preferred embodiments of the present disclosure, and is not intended to represent the only form in which the present disclosure may be practiced. It should be understood that the same or equivalent functions may be accomplished by different embodiments that are intended to be encompassed within the spirit and scope of the present disclosure.

To facilitate understanding, embodiments, which are illustrated in the accompanying drawings, are provided under specific network architecture and new service scenarios, such as 3GPP 5G, 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A wireless communication apparatus for wireless communication, comprising:
at least one memory; and
at least one processor coupled with the at least one processor and configured to cause the wireless communication apparatus to:
receive, from a serving cell on an active bandwidth part (BWP), a physical downlink control channel (PDCCH) order triggering a physical random access channel (PRACH) transmission associated with a candidate cell of a set of candidate cells,
wherein the set of candidate cells is configured by higher layer, and
wherein a center frequency of synchronization signal (SS)/physical broadcast channel (PBCH) block (SSB) from the candidate cell is different from a center frequency of SSB from the serving cell; and
transmit, to the candidate cell, the PRACH transmission, wherein a time between a last symbol of the PDCCH order and a first symbol of the PRACH transmission is equal to or greater than a threshold timing gap,
wherein the threshold timing gap is based on a radio frequency (RF) switching time.

2. The wireless communication apparatus of claim 1, wherein the threshold timing gap is: N_{T,2}+Δ_{BWPSwitching}+Δ_{Delay}+T_{switch}+T_{switch2} msec, wherein
N_{T,2} is a time duration of N₂ symbols corresponding to a physical uplink shared channel (PUSCH) preparation time for user equipment (UE) processing capability 1 when μ corresponds to a smallest subcarrier spacing (SCS) configuration between the SCS configuration of the PDCCH order and the SCS configuration of the corresponding PRACH transmission;
Δ_{BWPSwitching}=0 if the active BWP does not change and Δ_{BWPSwitching} is defined in TS 38.133; otherwise, Δ_{Delay}=0.5 msec for frequency range (FR) 1 and Δ_{Delay}=0.25 msec for FR2;
T_{switch} is a switching gap duration as defined in TS 38.214; and
T_{switch2} is the RF switching time.

3. The wireless communication apparatus of claim 1, wherein the at least one processor is further configured to cause the wireless communication apparatus to switch back to the frequency of the serving cell after a last symbol of the PRACH transmission.

4. The wireless communication apparatus of claim 3, wherein the at least one processor is further configured to cause the wireless communication apparatus to:
transmit uplink transmission in the serving cell during a time duration, wherein the time duration starts from a last symbol of the PDCCH order, and ends no earlier than summation of the last symbol of the PRACH transmission and the RF switching time;
suspend configured grant physical uplink shared channel (PUSCH) transmission in the serving cell during the time duration; or
drop all configured uplink (UL) transmissions in the serving cell during the time duration.

5. The wireless communication apparatus of claim 3, wherein a random access response (RAR) is configured for the PRACH transmission and is received in the serving cell, and a window for detecting the RAR in time division duplex (TDD) operation starts at a first symbol of an earliest control resource set (CORESET) when a user equipment (UE) is configured to receive PDCCH for Type1-PDCCH common search space (CSS) set, and is at least one symbol, after K orthogonal frequency division multiple access (OFDMA) symbols of the last symbol of the PRACH transmission, wherein the K OFDM symbols is summation of at least the RF switching time and a symbol duration corresponding to a subcarrier spacing (SCS) for Type1-PDCCH CSS set.

6. The wireless communication apparatus of claim 3, wherein a random access response (RAR) is configured for the PRACH transmission and is received in the serving cell, and the at least one processor is further configured to cause the wireless communication apparatus to retransmit the PRACH transmission no later than N_{T,1}+0.75+T_{switch2} msec after a last symbol of a window for detecting the RAR, or a last symbol of received physical downlink shared channel (PDSCH), wherein N_{T,1} is a time duration of N₁ symbols corresponding to a PDSCH processing time for UE processing capability 1 when μ corresponds to a smallest subcarrier spacing (SCS) configuration among SCS configurations for a PDCCH carrying downlink control information (DCI) format 1_0, a corresponding PDSCH in the case of additional PDSCH demodulation reference signal (DMRS) being configured, and a corresponding PRACH transmission, and T_{switch2} is the RF switching time.

7. The wireless communication apparatus of claim 1, wherein the at least one processor is further configured to cause the wireless communication apparatus to switch back to the frequency of the serving cell after a last symbol of a physical downlink shared channel (PDSCH) scheduled with random access (RA) radio network temporary identifier (RNTI) (RA-RNTI) corresponding to the PRACH transmission.

8. The wireless communication apparatus of claim 7, wherein the at least one processor is further configured to cause the wireless communication apparatus to:
transmit uplink (UL) transmission in the serving cell during a time duration, wherein the time duration starts from a last symbol of the PDCCH order and ends no earlier than summation of a last symbol of a PDSCH scheduled by RA-RNTI corresponding to the PRACH transmission and the RF switching time;
suspend configured grant physical uplink shared channel (PUSCH) transmission in the serving cell during the time duration; or
drop all configured UL transmissions in the serving cell during the time duration.

9. The wireless communication apparatus of claim 1, wherein the at least one processor is further configured to cause the wireless communication apparatus to:
determine whether to transmit the PRACH transmission when the PRACH transmission including any interruption due to RF switching time is overlapped with an uplink (UL) transmission in the serving cell or a cell set including the serving cell according to a predefined or configured rule; and
transmit the PRACH transmission when a priority of the PRACH transmission is higher than the UL transmission according to the predefined or configured rule.

10. The wireless communication apparatus of claim 9, wherein the UL transmission includes at least one of a sounding reference signal (SRS), a physical uplink control channel (PUCCH), or a physical shared uplink shared channel (PUSCH).

11. The wireless communication apparatus of claim 9, wherein the predefined or configured rule defines that a priority of a PRACH transmission associated with a candidate cell, wherein a center frequency of SSB from the candidate cell is different from a center frequency of SSB from the serving cell, is higher than a UL transmission in the serving cell or a cell set including the serving cell.

12. The wireless communication apparatus of claim 9, wherein the predefined or configured rule defines that a priority of a PRACH transmission associated with a candidate cell, wherein a center frequency of SSB from the candidate cell is different from a center frequency of SSB from the serving cell, is lower than a physical uplink control channel (PUCCH) or physical shared uplink shared channel (PUSCH) transmission in the serving cell or the cell set including the serving cell, but higher than all other UL transmission except for the PUCCH or PUSCH transmission in the serving cell or the cell set including the serving cell.

13. The wireless communication apparatus of claim 12, wherein the PUCCH or PUSCH transmission is a PUCCH or PUSCH transmission carrying hybrid automatic repeat request-acknowledge (HARQ-ACK), positive schedule request (SR), rank indicator (RI), channel state information (CSI)-reference signal (RS) resource indicator CRI, or SS/PBCH block (SSB) resource indicator (SSBRI).

14. The wireless communication apparatus of claim 1, wherein a first uplink (UL) slot applying a timing advance (TA) value associated with the candidate cell is determined according to the RF switching time.

15. The wireless communication apparatus of claim 14, wherein the first UL slot applying the TA value is determined to an application time of a cell switch command, or according to both legacy specification and the cell switch command.

16. The wireless communication apparatus of claim 1, wherein the RF switching time is max{switchingTimeUL, switchingTimeDL}, switchingTimeUL, or switchingTimeDL, wherein switchingTimeUL and switchingTimeDL are uplink (UL) RF switching time and downlink (DL) RF switching time, respectively.

17. A wireless communication apparatus for wireless communication, comprising:
at least one memory; and
at least one processor coupled with the at least one memory and configured to cause the wireless communication apparatus to:
transmit, to a user equipment (UE), from a serving cell on an active bandwidth part (BWP), a physical downlink control channel (PDCCH) order triggering a physical random access channel (PRACH) transmission associated with a candidate cell of a set of candidate cells, wherein the set of candidate cells is configured by higher layer, and a center frequency of synchronization signal (SS)/physical broadcast channel (PBCH) block (SSB) from the candidate cell is different from a center frequency of SSB from the serving cell; and
receive, from the UE, the PRACH transmission to the candidate cell, wherein a time between a last symbol of the PDCCH order and a first symbol of the PRACH transmission is equal to or greater than a threshold timing gap, wherein the threshold timing gap is based on a radio frequency (RF) switching time.

18. A method performed by a wireless communication apparatus, the method comprising:
receiving, from a serving cell on an active bandwidth part (BWP), a physical downlink control channel (PDCCH) order triggering a physical random access channel (PRACH) transmission associated with a candidate cell of a set of candidate cells, wherein the set of candidate cells is configured by higher layer, and a center frequency of synchronization signal (SS)/physical broadcast channel (PBCH) block (SSB) from the candidate cell is different from a center frequency of SSB from the serving cell; and
transmitting, to the candidate cell, the PRACH transmission, wherein a time between a last symbol of the PDCCH order and a first symbol of the PRACH transmission is equal to or greater than a threshold timing gap, wherein the threshold timing gap is based on a radio frequency (RF) switching time.

19. The method of claim 18, further comprising switching back to the frequency of the serving cell after a last symbol of the PRACH transmission.

20. A method performed by a wireless communication apparatus, the method comprising:
transmitting, to a user equipment (UE), from a serving cell on an active bandwidth part (BWP), a physical downlink control channel (PDCCH) order triggering a physical random access channel (PRACH) transmission associated with a candidate cell of a set of candidate cells, wherein the set of candidate cells is configured by higher layer, and a center frequency of synchronization signal (SS)/physical broadcast channel (PBCH) block (SSB) from the candidate cell is different from a center frequency of SSB from the serving cell; and
receiving, from the UE, the PRACH transmission to the candidate cell, wherein a time between a last symbol of the PDCCH order and a first symbol of the PRACH transmission is equal to or greater than a threshold timing gap, wherein the threshold timing gap is based on a radio frequency (RF) switching time.
